(19) United States
(12) Patent Application Publication
(10) Pub. No.: US 2009/0038605 A1
(43) Pub. Date: Feb. 12, 2009

(54) Portable cooking device

(76) Inventors: R. Scott Dahle, North Logan, UT (US); Roger G. Dahle, Providence, UT (US)

Correspondence Address: KEELY SCHNEITER, 399 NORTH MAIN, SUITE 300, LOGAN, UT, 84321, US

(21) Appl. No.: 12/148,729

(22) Filed: Apr. 21, 2008

Related U.S. Application Data
(60) Provisional application No. 60/925,381, filed on Apr. 20, 2007.

(51) Int. Cl. A47J 37/07

(52) U.S. Cl. 126/25 R; 126/9 B

(57) ABSTRACT

A portable outdoor cooking device includes a body portion having a heat source and a cooking attachment and support members attached to the body portion. The support members are collapsible and can be configured to fold and store beneath the body portion of the outdoor cooking device when the device is not in use. In addition, the cooking attachments are removable and interchangeable from the body portion of the outdoor cooking device. Side tables are also removably attached to the body portion of the device.

### CROSS-REFERENCE TO RELATED APPLICATIONS

This application claim priority to U.S. Provisional Patent Application No. 60/925,381, filed Apr. 20, 2007, and entitled, “Portable Grill and Griddle,” which is incorporated herein by reference in its entirety.

### BACKGROUND OF THE INVENTION

1. The Field of the Invention

This invention relates generally to cooking devices. More particularly, embodiments of the present invention relate to portable cooking devices suitable for outdoor use.

2. Related Technology

Cooking outdoors has long been a common way to prepare food. With time, preparing meals over an outdoor fire has evolved from a necessity to a recreational activity. Although preparing food outdoors over a campfire may still appeal to many, what was once done over a campfire can now be done using a variety of outdoor cooking devices, including ovens, stoves, grills, and more. Today cooking meals outdoors is a popular way to enjoy pleasant weather, feed individuals or groups, and entertain small parties or large crowds.

As mentioned above, outdoor cooking devices come in many varieties. Some devices, such as camp stoves and Dutch ovens, are typically used over an outdoor fire when camping or hiking. Other devices, such as grills and griddles, are typically less portable and used near homes or in yards. Varieties of these outdoor cooking devices rely on various types of fuel for cooking food, such as, for example, charcoal, electricity, and propane gas. Thus, such outdoor cooking devices allow users to cook quality meals outdoors for recreational, entertainment, and a variety of other purposes.

While outdoor cooking devices allow users to prepare meals outdoors, such devices are often inconvenient in set-up and configuration. For example, many outdoor cooking devices do not provide sufficient space for storing food items before or after they have been cooked. Outdoor cooking devices also often lack sufficient cooking surface area. In addition, outdoor cooking devices can be difficult to maintain, difficult to clean, and difficult to transport, should the need or desire arise. In short, outdoor cooking devices, though widely used, are still in many ways inconvenient and difficult to use and maintain.

What is needed are outdoor cooking devices that provide adequate space for cooking and preparing food, are easily maintained and cleaned, and can be transported without difficulty.

### BRIEF DESCRIPTION OF THE DRAWINGS

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings are not drawn to scale. The invention will be described and explained with additional specificity and detail through the use of the accompanying drawings in which:

FIG. 1 shows an outdoor cooking device.

### DETAILED DESCRIPTION OF EXEMPLARY EMBODIMENTS

Embodiments of the present invention include outdoor cooking devices configured to transport easily and to offer a wide range of cooking options. In one embodiment of the invention, an outdoor cooking device includes multiple interchangeable cooking attachments, such as, for example, a grill attachment and a griddle attachment. Various heat sources located beneath the attachment, when the attachment is connected to the body of the outdoor cooking device, control the temperature of the attached cooking surface. Detachable and collapsible side tables provide additional storage and preparation surfaces. Other elements of the invention, as described in further detail below, further enhance the utility and convenience of the outdoor cooking device.

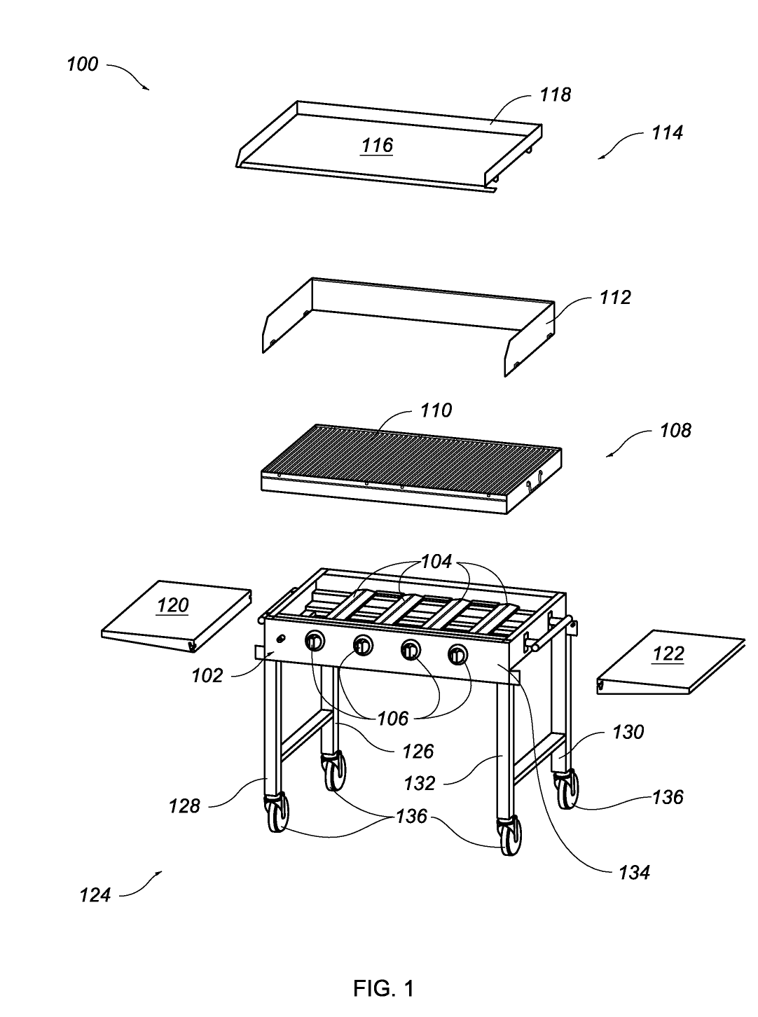

With attention now to FIG. 1, an expanded view of outdoor cooking device 100 is shown. Body portion 102 includes heating elements 104 and temperature control knobs 106. The body portion 102 is further connected to a fuel source, such as, for example, propane gas or electricity, which supplies fuel to the heating elements 104. In one embodiment of the invention where the outdoor cooking device 100 operates using propane gas, heating elements 104 are gas burners.

In addition to body portion 102, outdoor cooking device 100 also includes a cooking attachment. In one embodiment of the invention, the cooking attachment is grill 108 having a cooking surface 110. In other embodiments of the invention, the cooking attachment is a griddle, a Dutch oven, or any other cooking attachment. Each cooking attachment is configured to be removably attached to the body portion 102. Stated differently, each cooking attachment fits onto body portion 102 and can be secured onto body portion 102 when a user desires to use a particular cooking attachment. Each cooking attachment is also easily removed from body portion 102 so that, when a user desires to use a different cooking attachment, a cooking attachment can be easily removed from body portion 102 and replaced by another cooking attachment. In this way, the cooking attachments are interchangeable on body portion 102 of the device.

Grill 108 has a size and shape configured to fit securely over body portion 102 of the cooking device 100. A grill guard 112 is configured to attach to the sides and back of grill 108, thus surrounding grill 108 on three sides and serving to provide a barrier to prevent items placed on grill 108 from falling off grill 108.

Likewise, griddle 114, having a cooking surface 116, is surrounded on three sides by a wall 118 that serves as a barrier to prevent items placed on griddle 114 from falling off griddle 114. In one embodiment of the invention, griddle 114 is made of metal or other material suitable for a cooking surface, such as, for example, cast iron, stainless steel, copper, ceramic, or any other material. Griddle 114, like grill 108, has a size and shape configured to fit securely over body portion 102 when griddle 114 is in use.

In operation, when cooking device 100 is in use one of the cooking attachments, such as grill 108 or griddle 114, is attached to body portion 102. When grill 108 is attached to body portion 102, grill guard 112 may be further attached to grill 108. Food is placed on cooking surface 110 to cook, or, when griddle 114 is in use, food is placed on cooking surface 116 to cook. While grill 108 is in used, griddle 114 may be stored on cooking device 100. Likewise, when griddle 114 is in use, grill 108 may be stored on cooking device 100. For this purpose, embodiments of the present invention include a storage system (not shown) for grill 108, griddle 114, and any other cooking attachments that may be removable from body portion 102 so that when cooking attachments are not in use they may be conveniently stored on the cooking device 100. In one embodiment of the invention the storage system includes hooks that attach to the body portion 102 and from which the grill 108, griddle 114, or any other cooking attachment may hang.

When either grill 108 or griddle 114 is in use, knobs 106 located on body portion 102 control the temperature of heat sources 104. Each heat source 104 is associated with a separate knob 106, which allows for the temperature of each heat source 104 to be controlled separately. Stated differently, each heat source 104 is independently controlled by a corresponding temperature control knob 106. Thus, food on one portion of the grill 108 or griddle 114 may be cooked at a different temperature than food on a different portion of the grill 108 or griddle 114.

The operating convenience of cooking device 100 is further enhanced, in one embodiment of the invention, by detachable and collapsible side tables 120 and 122, each of which attaches to a side of body portion 102. In one embodiment of the invention side tables 120 and 122 provide additional preparation surfaces and workspaces. Side tables 120 and 122 are collapsible and can be positioned to be oriented along the plane of cooking surfaces 110 or 116, also referred to as an upright position, or side portions 118 and 120 may fold down in a position orthogonal to the plane of cooking surfaces 110 and 116, also referred to as a storage position. Side tables 120 and 122 are easily removable from body portion 102 of outdoor cooking device 100 and easily secured in the upright position when in use.

In addition to the elements outlined and described above, the outdoor cooking device includes a collapsible support system, designated generally at 124. In one embodiment of the invention the collapsible support system includes support members 126, 128, 130 and 132, each of which attaches at one end to body portion 102. More specifically, in one embodiment of the invention each of support members 126, 128, 130, and 132 include a first end that attaches to body portion 102 at a corner of body portion 102. For example, support member 132 attaches to body portion 102 at corner 134 of body portion 102. In one embodiment of the invention each of support members 126, 128, 130, and 132 pivotally attaches to body portion 102 enabling each of support members 126, 128, 130, and 132 to be rotated to securely store in a bottom portion of body portion 102.

Support members 126, 128, 130, and 132 extend from body portion 102 in a configuration orthogonal to the plane of cooking surfaces 110 and 116. In one embodiment of the invention wheels 136 attach to each of support members 126, 128, 130, and 132 at a second end. Wheels 136 enable outdoor cooking device 100 to be transported from one location to another by rolling the outdoor cooking device 100 along a surface.

Further, as noted above, in one embodiment of the invention support members 126, 128, 130, and 132 are collapsible. For example, support members 118, 120, 122, and 124 may fold at the comers of body portion 102 so that support members 126, 128, 130, and 132 are moved from a position orthogonal to the plane of cooking surfaces 110 and 116 to a position parallel to the plane of cooking surfaces 110 and 116. When support members 126, 128, 130, and 132 have been collapsed and are folded under body portion 102, support members 126, 128, 130, and 132 may be secured beneath body portion 102 in a variety of ways. For example, in one embodiment of the invention support members 126, 128, 130, and 132 are secured beneath body portion 102 with a pin or other fastener.

Outdoor cooking device 100 also includes various fasteners and attachments to maintain parts of outdoor cooking device in a secure position when the device is in use. These addition parts include, for example, additional support members for securing support members 126, 128, 130, and 132 in an upright position, and various fastening and supporting elements to secure the grill 108, griddle 114, grill guard 112, and other parts of the outdoor cooking device 100. In addition, outdoor cooking device 100 may also include other cooking surface attachments, such as, for example, a Dutch oven attachment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A portable outdoor cooking device, comprising:
a body portion, wherein the body portion includes at least one heat source and at least one temperature control knob for controlling the at least one heat source;
a cooking attachment configured to be removably attached to the body portion when the cooking surface is in use, and further configured to attach to a storage system located on the body portion of the cooking device when the cooking surface is not in use; and
a collapsible support system having two or more support members pivotally attached to the body portion of the cooking device.

2. The device as recited in claim 1, further comprising one or more side tables removably attached to the body portion.

3. The device as recited in claim 2, wherein the one or more side tables are collapsible.

4. The device as recited in claim 3, wherein the one or more side tables are configured to be positioned in one of: an upright position; and, a storage position.

5. The device as recited in claim 1, wherein the cooking attachment is one of: a griddle; a grill; and, a Dutch oven.

6. The device as recited in claim 5, wherein the cooking attachment is configured of one or more of: cast iron; stainless steel; copper; and, ceramic.

7. The device as recited in claim 5, wherein the grill further includes a grill guard.

8. The device as recited in claim 1, wherein a temperature of each of the at least one heat sources is independently controlled by a corresponding temperature control knob.

9. The device as recited in claim 1, wherein the two or more support members further include wheels.

10. The device as recited in claim 1, wherein the two or more support members are configured to securely store in a bottom portion of the body portion.

11. The device as recited in claim 1, wherein the storage system includes hooks.

12. The device as recited in claim 1, wherein the device further attaches to a fuel source.

13. The device as recited in claim 12, wherein the fuel source is one of: propane; and, electricity.

14. A cooking device, comprising:
a body portion, wherein the body portion includes at least one heat source;
one or more cooking attachments, wherein the cooking attaching is configured to removably attach to the body portion of the device, the cooking attachment further including a cooking surface;
at least one side table, the side table configured to be removably attached to the body portion of the device, the at least one side table further configured to have an upright position and a storage position;
a support system attached to the body portion, the support system including support members, the support system configured to collapse and fold into the body portion; and
a storage system located on the body portion of the device configured to store the cooking attachment when the cooking attachment is not in use.

15. The device as recited in claim 14, wherein the body portion further includes at least one temperature control knob coupled to the at least one heat source and configured to control the temperature of the at least one heat source.

16. The device as recited in claim 14, wherein each of the support members has a first end, the first end being attached to the body portion, and a second end, the second end being attached to a wheel.

17. The device as recited in claim 14, wherein the cooking attachment is one of: a grill; a griddle; or, a Dutch oven.

18. The device as recited in claim 17, wherein the grill further includes a grill guard.

19. The device as recited in claim 14, wherein the storage system includes hooks.

20. The device as recited in claim 14, wherein the one or more cooking attachments are interchangeable on the body portion of the device.
